(19) United States
(12) Patent Application Publication
(10) Pub. No.: US 2026/0309516 A1
(43) Pub. Date: Oct. 8, 2026

(54) ENCODER AND MOTOR

(71) Applicant: MITSUBISHI ELECTRIC CORPORATION, Tokyo (JP)

(72) Inventors: Hiroshi NAGATA, Tokyo (JP); Masahiro NAKAJIMA, Tokyo (JP)

(73) Assignee: MITSUBISHI ELECTRIC CORPORATION, Tokyo (JP)

(21) Appl. No.: 19/491,441

(22) PCT Filed: Aug. 23, 2023
(86) PCT No.: PCT/JP2023/030350

§ 371 Date: Dec. 9, 2025

(51) Int. Cl. G01D 5/20; H02P 6/16

(52) U.S. Cl. CPC G01D 5/2033; H02P 6/16

(57) ABSTRACT

An encoder includes power generation devices that cause first pulses to arise by wires and second pulses to arise by coils as a magnet attached to a rotating shaft rotates, capacitors that accumulate electric charges of the first pulses and the second pulses, a pulse detector that outputs a pulse detection signal when a voltage of each of the capacitors exceeds a pulse detection threshold, and a controller that performs counting operation to count up multi-rotation data on the basis of the pulse detection signal, wait operation to wait for a waiting time after the counting operation, and discharging operation to discharge the capacitors after the wait operation. The waiting time is a time that at least allows completion of storing of the electric charge of each of the first pulses, and causes no increase in the voltages of the capacitors.

### FIELD

The present disclosure relates: to an encoder that performs counting operation to count a power generation pulse generated by a power generation device, using the electric charge of the power generation pulse; and to a motor including the encoder.

### BACKGROUND

One known power generation device for use in a type of encoder that performs counting operation to count a power generation pulse generated by the power generation device, using the electric charge of the power generation pulse, is a Wiegand wire. A Wiegand wire causes a power generation pulse to arise by large Barkhausen effect as the shaft rotates. As disclosed in Patent Literature 1, an encoder using a Wiegand wire as a power generation device stores the electric charge of a power generation pulse in a capacitor to use the electric charge as a power source for a counting operation circuitry, and performs counting operation to count the pulse generated by the power generation device.

An encoder that uses a Wiegand wire as a power generation device performs discharging operation to discharge the capacitor after completion of the counting operation. This brings a next power generation pulse detectable.

### CITATION LIST

### Patent Literature

Patent Literature 1: Japanese Patent Application Laid-open No. 2021-1908

### SUMMARY OF INVENTION

### Problem to be Solved by the Invention

The amount of electric charge supplied by the power generation device is featured by a significant variation depending on conditions such as the rotational speed of the shaft, the temperature, and the start position of reversal. Accordingly, electric charge supply from the power generation device is not necessarily completed at the time of completion of the counting operation. As such, when an encoder that uses a Wiegand wire as a power generation device performs discharging operation to discharge the capacitor at the time of completion of the counting operation, and electric charge supply from the power generation device to the capacitor is still in process at the time of completion of the counting operation, another electric charge may be newly accumulated in the capacitor, thereby causing a power generation pulse to be counted redundantly.

The present disclosure has been made in view of the foregoing, and it is an object of the present disclosure to provide an encoder that suppresses a power generation pulse from being counted redundantly.

### Means to Solve the Problem

To solve the above problems and achieve the object an encoder according to the present disclosure includes: a magnet attached to a rotating shaft; a power generation device including a Wiegand wire and a coil wound around the Wiegand wire. The power generation device is disposed to face the magnet and configured to generate a first pulse by the Wiegand wire due to large Barkhausen effect as the magnet rotates, and generate a second pulse by the coil due to induced electromotive force as the magnet rotates. The encoder further includes: a capacitor configured to accumulate electric charges of the first pulse and the second pulse; a pulse detector configured to output a pulse detection signal when a voltage of the capacitor exceeds a pulse detection threshold; and a controller. The controller: is operable by electric power supplied from the capacitor; performs counting operation as an operation to count up multi-rotation data on a basis of the pulse detection signal; performs a wait operation to wait for a preset waiting time; and performs a discharging operation to discharge the capacitor after the wait operation. The waiting time is a time that at least accumulating of the electric charge of the first pulse is completed, and there is no increase in the voltage of the capacitor.

### Effects of the Invention

An encoder according to the present disclosure provides an advantageous effect in suppressing a power generation pulse from being counted redundantly.

### BRIEF DESCRIPTION OF DRAWINGS

FIG. 1 is a diagram illustrating a configuration of a motor according to a first embodiment.

FIG. 2 is a diagram illustrating an example of power generation pulse waveforms of power generation devices of a batteryless encoder according to the first embodiment.

FIG. 3 is a diagram illustrating an example of power generation pulse waveform of a capacitor of the batteryless encoder according to the first embodiment.

FIG. 4 is a diagram illustrating a power generation pulse waveform of a capacitor of a batteryless encoder according to a first comparative example with regard to the first embodiment.

FIG. 5 is a diagram illustrating a power generation pulse waveform of a capacitor of a batteryless encoder according to a second comparative example with regard to the first embodiment.

FIG. 6 is a diagram illustrating a power generation pulse waveform of a capacitor of a batteryless encoder according to a third comparative example with regard to the first embodiment.

FIG. 7 is a diagram illustrating an example of power generation pulse waveform in an unpowered state, of the batteryless encoder according to the first embodiment.

FIG. 8 is a diagram illustrating an example of power generation pulse waveform in a powered state, of the batteryless encoder according to the first embodiment.

FIG. 9 is a diagram illustrating an example of power generation pulse waveforms of the power generation devices of the batteryless encoder according to a variation of the first embodiment.

FIG. 10 is a diagram illustrating an example of power generation pulse waveform of a capacitor of the batteryless encoder according to the variation of the first embodiment.

FIG. 11 is a diagram illustrating a hardware configuration of a controller and a storage of the batteryless encoder according to the first embodiment and the variation.

### DESCRIPTION OF EMBODIMENTS

An encoder and a motor according to an embodiment will be described in detail below with reference to the drawings.

### First Embodiment

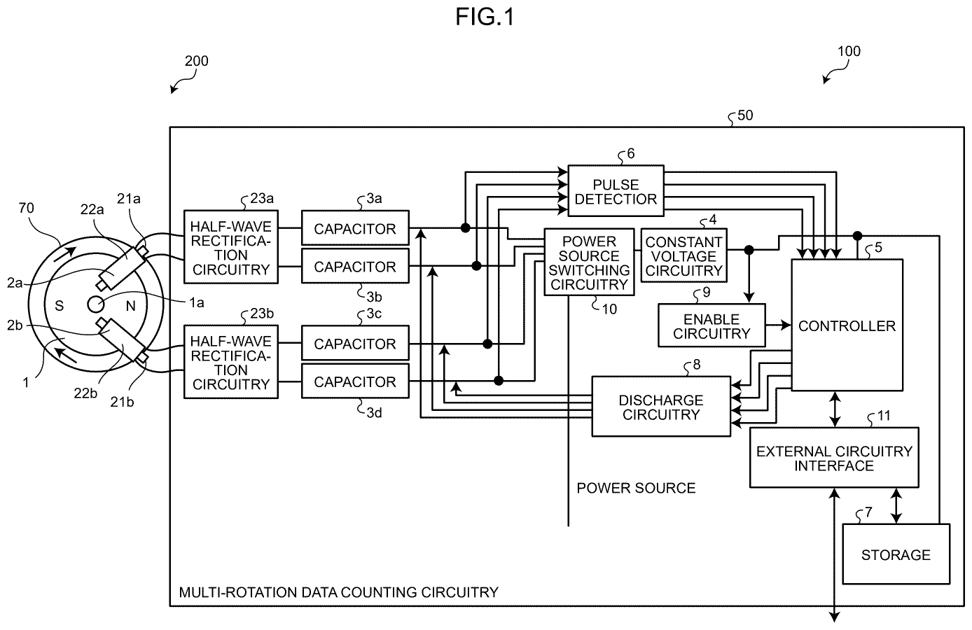

FIG. 1 is a diagram illustrating a configuration of a motor according to a first embodiment. A motor 200 according to the first embodiment includes: an electric motor drive 70 including a rotating shaft 1a; and a batteryless encoder 100 configured to detect a rotation angle of the rotating shaft 1a. The batteryless encoder 100 includes: a magnet 1 fixed to the rotating shaft 1a; two power generation devices 2a and 2b disposed to face the magnet 1; and a multi-rotation data counting circuitry 50. The multi-rotation data counting circuitry 50 includes: a half-wave rectification circuitry 23a that rectifies an alternating current (AC) current generated in the power generation device 2a; a half-wave rectification circuitry 23b that rectifies an AC current generated in the power generation device 2b; capacitors 3a and 3b that accumulates an electric charge of a direct current (DC) current output by the half-wave rectification circuitry 23a; capacitors 3c and 3d that accumulates an electric charge of a DC current output by the half-wave rectification circuitry 23b; a constant voltage circuitry 4 that outputs a DC current having a voltage regulated to a voltage equal to or less than a preset voltage; and a discharge circuitry 8 that discharges the capacitors 3a, 3b, 3c, and 3d. Note that the batteryless encoder 100 is an encoder including no built-in batteries in the encoder in addition to the capacitors 3a, 3b, 3c, and 3d. The present disclosure is, however, applicable to an encoder including a built-in battery in the encoder in addition to the capacitors 3a, 3b, 3c, and 3d.

Each of the power generation devices 2a and 2b includes: wires 21a and 21b that are Wiegand wires; and coils 22a and 22b that are wound around the wires 21a and 21b.

The multi-rotation data counting circuitry 50 also includes: a pulse detector 6 that outputs a pulse detection signal when one of the voltages of the capacitors 3a, 3b, 3c, and 3d exceeds a pulse detection threshold, where the pulse detection signal indicates that a pulse has been detected, and the voltages of the capacitors 3a, 3b, 3c, and 3d vary depending on the electric charges accumulated in the respective capacitors 3a, 3b, 3c, and 3d; a storage 7 that stores multi-rotation count data in a non-volatile memory; and controller 5 that generates multi-rotation count data based on the multi-rotation count data read from the storage 7 and the pulse detection signal input from the pulse detector 6, and updates the multi-rotation count data in the storage 7. The pulse detection signal is a signal different from one another with respect to the capacitors 3a, 3b, 3c, and 3d. This enables the controller 5 to identify a pulse occurrence position on the basis of which of the capacitors 3a, 3b, 3c, and 3d the pulse detection signal corresponds to.

The controller 5 is operable by electric power supplied from the capacitors 3a, 3b, 3c, and 3d, or operates by electric power supplied from outside the multi-rotation data counting circuitry 50. The controller 5 performs: counting operation to count up multi-rotation data on the basis of the pulse detection signal; wait operation to wait for a preset waiting time after the counting operation; and discharging operation to discharge the capacitors 3a, 3b, 3c, and 3d after the wait operation. As the controller 5 performs the counting operation, the rotation angle of the rotating shaft 1a is detected.

The controller 5 writes in information to the storage 7 and reads out information from the storage 7 via an external circuitry interface 11. In addition, the controller 5 can output the count data to a device external to the multi-rotation data counting circuitry 50 via the external circuitry interface 11.

After the counting operation, the controller 5 performs the wait operation, and then sends a command to the discharge circuitry 8 to discharge the capacitors 3a, 3b, 3c, and 3d. The waiting time can be set to different values: for an unpowered state, in which no electric power is supplied from outside the multi-rotation data counting circuitry 50; and for a powered state, in which electric power is supplied from outside the multi-rotation data counting circuitry 50.

When the voltage of the DC current output by the constant voltage circuitry 4 reaches a predetermined voltage, an enable circuitry 9: releases a reset state, in which no counting operation using a pulse detection signal is performed; and causes the controller 5 to transition to a state in which the counting operation can be performed.

In an unpowered state, in which no electric power is supplied from outside the multi-rotation data counting circuitry 50, a power source switching circuitry 10 outputs the electric power supplied from the capacitors 3a, 3b, 3c, and 3d to the constant voltage circuitry 4. Meanwhile, in a powered state in which the electric power is supplied from outside the multi-rotation data counting circuitry 50, the power source switching circuitry 10 outputs the electric power supplied from outside to the constant voltage circuitry 4. Note that examples of the electric power supplied from outside the multi-rotation data counting circuitry 50 include, but not limited to, electric power generated in the batteryless encoder 100 on the basis of electric power supplied from an amplifier (not illustrated). For example, when the encoder includes a built-in battery, the electric power supplied from outside the multi-rotation data counting circuitry 50 can be electric power supplied from the built-in battery.

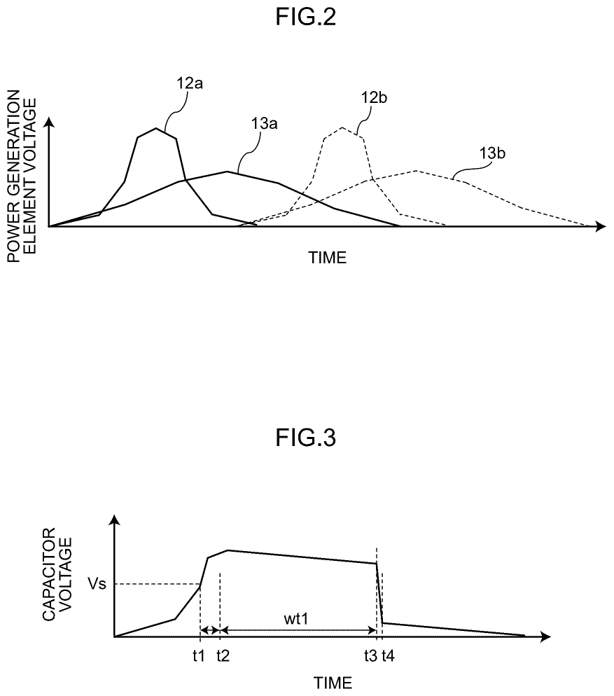

FIG. 2 is a diagram illustrating an example of power generation pulse waveforms of the power generation devices of the batteryless encoder according to the first embodiment. Power generation pulses include: first pulses 12a and 12b that is generated due to large Barkhausen effect of the wires 21a and 21b as the magnet 1 rotates; and second pulses 13a and 13b that is generated due to induced electromotive force of the coils 22a and 22b as the magnet 1 rotates. Note that FIG. 2 indicates the waveforms of the first pulse 12a and the second pulse 13a generated in the power generation device 2a by solid lines, and the waveforms of the first pulse 12b and the second pulse 13b generated in the power generation device 2b by broken lines. The second pulses 13a and 13b will have higher amplitudes at a higher rotational speed of the magnet 1. Due to different installation positions of the power generation device 2a and the power generation device 2b, the first pulse 12a and the first pulse 12b are generated at different timings, and the second pulse 13a and the second pulse 13b are generated at different timings.

The first pulse 12a and the second pulse 13a have voltage peaks at different timings, but are generated at a same timing in terms of a specific rotation angle of the magnet 1. Accordingly, the first pulse 12a and the second pulse 13a are counted redundantly the number of revolutions of the magnet 1 is not counted accurately. This also applies to the pair of the first pulse 12b and the second pulse 13b. That is, the first pulse 12b and the second pulse 13b are counted redundantly the number of revolutions of the magnet 1 is not counted accurately. Therefore, in the batteryless encoder 100 according to the first embodiment the waiting time is set to at least a time of accumulating of the electric charges of the first pulses 12a and 12b and the second pulses 13a and 13b are completed, and there is no increase in the voltages of the capacitors 3a, 3b, 3c, and 3d.

Detailed description will next be given for the batteryless encoder 100 illustrated in FIG. 1. The batteryless encoder 100 includes the four capacitors 3a, 3b, 3c, and 3d, the waiting time can be set to a time: when accumulating of the electric charges of the first pulses 12a and 12b and the second pulses 13a and 13b of one of the capacitors 3a, 3b, 3c, and 3d is completed; and there is no increase in the voltages of the capacitors 3a, 3b, 3c, and 3d. Specifically, in the capacitor 3a, the waiting time can be set to a time when accumulating of the electric charges of the first pulses 12a and the second pulses 13a is completed and there is no increase in the voltage of the capacitor 3a. Note, in each of the capacitors 3a, 3b, 3c, and 3d, the time of accumulating the electric charges of the first pulses 12a and 12b and the second pulses 13a and 13b are completed and the time there is no increase in the voltages of the capacitors 3a, 3b, 3c, and 3d is the same for all the capacitors 3a, 3b, 3c, and 3d. The waiting time may therefore be set to a time: in the capacitor 3b, when accumulating the electric charges of the first pulses 12a and the second pulses 13a are completed, and there in no increase in the voltage of the capacitor 3b; in the capacitor 3c, when accumulating the electric charges of the first pulses 12b and the second pulses 13b are completed, and there in no increase in the voltage of the capacitor 3c; and in the capacitor 3d, when accumulating the electric charges of the first pulses 12b and the second pulses 13b are completed, and there in no increase in the voltage of the capacitor 3d.

The controller 5 counts the preceding first pulses 12a and 12b, and then performs the wait operation to wait for a preset time, during which the controller 5 performs no counting operation even when, for example, one of the first pulses 12a and 12b and the second pulses 13a and 13b exceeds a pulse detection threshold. This can suppress counting redundantly the first pulses 12a and 12b that have already been counted, and can suppress counting, as different pulses, the first pulses 12a and 12b and the second pulses 13a and 13b.

However, after counting the first pulse 12a, by the time the first pulse 12b is generated, if the wait operation is not completed and discharges of the capacitors 3a, 3b, 3c, and 3d are not done, the first pulse 12b will not be counted. As such, the controller 5 needs to cause the state to transition to a state in which the first pulse 12b can be counted as early as possible after counting the first pulse 12a. It is therefore preferable to set the waiting time to a time almost the same as the time accumulation of the electric charges of the first pulses 12a and 12b and the second pulses 13a and 13b are completed, and there is no increase in the voltages of the capacitors 3a, 3b, 3c, and 3d.

The pulse durations of the first pulses 12a and 12b and the second pulses 13a and 13b decrease as the rotational speed of the magnet 1 increases. Thus, the waiting time in the wait operation may be set stepwise in such a manner that a shorter time is set for a higher rotational speed of the magnet 1.

An operation of the batteryless encoder 100 according to the first embodiment will next be described for a case, as an example, where the counting operation is performed on the first pulse 12a. FIG. 3 is a diagram illustrating an example of power generation pulse waveform of a corresponding capacitor of the batteryless encoder according to the first embodiment. At time t1, the controller 5 starts the counting operation as the voltage of the capacitor 3a exceeds a pulse detection threshold Vs. At time t2, when the counting operation finishes, the controller 5 performs the wait operation. After waiting for preset waiting time wt1, i.e., at time t3, the controller 5 performs the discharging operation to operate the discharge circuitry 8 to discharge the capacitor 3a. Waiting time wt1 is a time that at least accumulating of the electric charges of the first pulse 12a and the second pulse 13a is completed, and there is no increase in the voltages of the capacitors 3a and 3b. At time t4, when the discharging operation finishes, the voltage of the capacitor 3a falls below the pulse detection threshold Vs, under which condition the first pulses 12a and 12b are detectable.

In the batteryless encoder 100 according to the first embodiment, the controller 5 discharges the capacitor 3a after performing the counting operation of the first pulse 12a and at a time when electric charge supply from both of the first pulse 12a and the second pulse 13a has ended. This suppresses a situation in which the amount of electric charge in the capacitor 3a increases and the voltage of the capacitor 3a increases again after performing the discharge operation. This can thus suppress counting redundantly the first pulse 12a that has already been counted, and can suppress counting, as two different pulses, the first pulse 12a and the second pulse 13a. The first pulses 12a and 12b can be detected immediately after the discharging operation is performed.

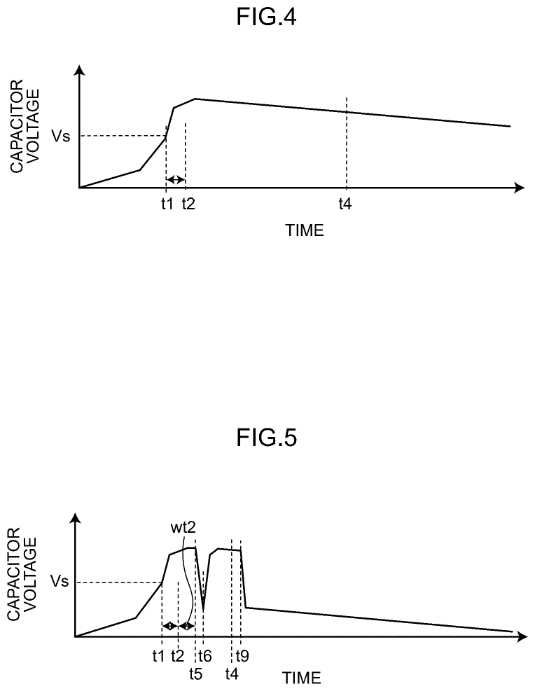

FIG. 4 is a diagram illustrating a power generation pulse waveform of a capacitor of a batteryless encoder according to a first comparative example with regard to the first embodiment. At time t1, the controller starts the counting operation as the voltage of the capacitor exceeds the pulse detection threshold Vs. At time t2, the counting operation finishes, but the batteryless encoder according to the first comparative example performs no discharging operation after performing the counting operation of a first pulse. Therefore, at time t4, the voltage of the capacitor is equal to the pulse detection threshold Vs or greater. As described above, when neither the wait operation nor the discharging operation is performed after completion of the counting operation, the first pulse is undetectable until the electric charge of the capacitor decreases by self-discharge. This creates difficulty in detecting a next first pulse when the rate of rotation of the rotating shaft increases to reach a high-speed rotation in which the rate of rotation is higher than or equal to a certain rate of rotation.

FIG. 5 is a diagram illustrating a power generation pulse waveform of a capacitor of a batteryless encoder according to a second comparative example with regard to the first embodiment. At time t1, the controller starts the counting operation as the voltage of the capacitor exceeds the pulse detection threshold Vs. At time t2, when the counting operation finishes, the controller performs the wait operation. The batteryless encoder according to the second comparative example with regard to the first embodiment has set waiting time wt2 to a time shorter than the time accumulating the electric charge of a first pulse in the capacitor is completed, and there is no increase in the voltages of the capacitors 3a, 3b, 3c, and 3d. After waiting for preset waiting time wt2, i.e., at time t5, the controller performs the discharging operation to operate the discharge circuitry to discharge the capacitor. At time t6, when the discharging operation finishes, the voltage of the capacitor falls below the pulse detection threshold Vs. However, electric charge supply from the first pulse is still in process, thereby causing the amount of electric charge of the capacitor to increase again, and the voltage of the capacitor to increase again. This causes, at time t4, the voltage of the capacitor to be greater than or equal to the pulse detection threshold Vs.

The batteryless encoder according to the second comparative example performs the discharging operation after performing the counting operation of the first pulse, but at a time when electric charge supply from the first pulse is still in process. Although the discharging operation reduces the amount of electric charge of the capacitor, the first pulse supplies electric charge to the capacitor after completion of the discharging operation. This causes the amount of electric charge of the capacitor to increase again, and the voltage of the capacitor to increase again. This second increase in the amount of electric charge of the capacitor causes the voltage of the capacitor to again exceed the pulse detection threshold Vs, thereby causing the controller to start the counting operation again. The batteryless encoder according to the second comparative example accordingly counts redundantly the power generation pulse that has already been counted. This leads to an error in the rotation angle of the rotating shaft. In addition, the first pulse is undetectable during a time period after the electric charge of the capacitor has increased again until the electric charge of the capacitor decreases by being discharged again at time t9. This creates difficulty in detecting a next first pulse when the rate of rotation of the rotating shaft increases to reach a high-speed rotation in which the rate of rotation is higher than or equal to a certain rate of rotation.

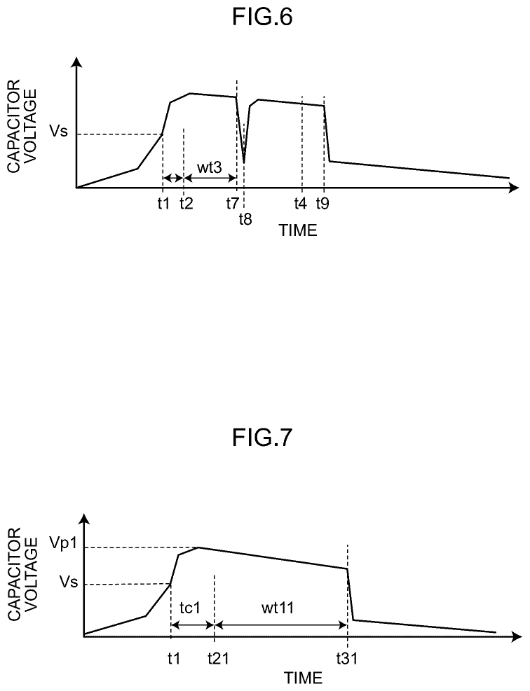

FIG. 6 is a diagram illustrating a power generation pulse waveform of a capacitor of a batteryless encoder according to a third comparative example with regard to the first embodiment. At time t1, the controller starts the counting operation as the voltage of the capacitor exceeds the pulse detection threshold Vs. At time t2, when the counting operation finishes, the controller performs the wait operation. The batteryless encoder according to the third comparative example with regard to the first embodiment has set waiting time wt3 to a time shorter than accumulating the electric charge of a first pulse in the capacitor is completed, and the electric charge of a second pulse is being accumulated in the capacitor, and there is no increase in the voltages of the capacitors 3a, 3b, 3c, and 3d caused by accumulating of the electric charge of the second pulse. After waiting for preset waiting time wt3, i.e., at time t7, the controller performs the discharging operation to operate the discharge circuitry to discharge the capacitor. At time t8, when the discharging operation finishes, the voltage of the capacitor falls below the pulse detection threshold Vs. However, electric charge supply from the second pulse is still in process, thereby causing the amount of electric charge of the capacitor to increase again, and the voltage of the capacitor to increase again. This causes, at time t4, the voltage of the capacitor to be greater than or equal to the pulse detection threshold Vs.

The batteryless encoder according to the third comparative example performs the discharging operation after performing the counting operation of the first pulse, but at a time when electric charge supply from the second pulse is still in process. Although the discharging operation reduces the amount of electric charge of the capacitor, the second pulse supplies electric charge after completion of the discharging operation. This causes the amount of electric charge of the capacitor to increase again, and the voltage of the capacitor to increase again. This second increase in the amount of electric charge of the capacitor causes the voltage of the capacitor to again exceed the pulse detection threshold Vs, thereby causing the controller to start the counting operation again. The batteryless encoder according to the third comparative example accordingly counts, as two different pulses, the first pulse and the second pulse in a same rate of rotation of the rotating shaft. This leads to an error in the rotation angle of the rotating shaft. In addition, the first pulse is undetectable during a time period after the amount of electric charge of the capacitor has increased again until the electric charge of the capacitor decreases by being discharged again at time t9. This creates difficulty in detecting a next first pulse in high-speed rotation in which the rate of rotation of the rotating shaft is higher than or equal to a certain rate of rotation.

As described above, performing no discharging operation or performing discharging operation during a process of electric charge supply from the first pulse or the second pulse may cause the first pulse that has already been counted to be counted redundantly or the first pulse and the second pulse to be counted as two different pulses. This leads to an error in the rotation angle of the rotating shaft. This may also increase the time required for the voltage of the capacitor to decrease to a detectable level of a subsequent first pulse. This creates difficulty in detecting a next power generation pulse when the rate of rotation of the rotating shaft increases to reach a high-speed rotation in which the rate of rotation is higher than or equal to a certain rate of rotation. In contrast, the batteryless encoder 100 according to the first embodiment performs the discharging operation at a time when electric charge supply from both of the first pulse 12a and the second pulse 13a has ended. This can suppress counting redundantly the first pulses 12a and 12b that have already been counted, and can suppress counting, as different pulses, the first pulses 12a and 12b and the second pulses 13a and 13b. In addition, this reduces the time required for the voltages of the capacitors 3a, 3b, 3c, and 3d to decrease to a detectable level of the first pulses 12a and 12b, thereby enabling a detection in a high-speed rotation.

Here, a difference in operation between an unpowered state and a powered state will be described. First, an operation in the unpowered state will be described. Rotation of the magnet 1 attached to the rotating shaft 1a causes a power generation pulse to arise in each of the power generation devices 2a and 2b due to large Barkhausen effect. Of the voltage pulses output by the power generation device 2a, the forward-direction voltage pulse is half-wave rectified by the half-wave rectification circuitry 23a, and the resulting voltage pulse is transmitted to the capacitor 3a. Of the voltage pulses output by the power generation device 2a, the inverse-direction voltage pulse is half-wave rectified by the half-wave rectification circuitry 23a, and the resulting voltage pulse is transmitted to the capacitor 3b. Of the voltage pulses output by the power generation device 2b, the forward-direction voltage pulse is half-wave rectified by the half-wave rectification circuitry 23b, and the resulting voltage pulse is transmitted to the capacitor 3c. Of the voltage pulses output by the power generation device 2b, the inverse-direction voltage pulse is half-wave rectified by the half-wave rectification circuitry 23b, and the resulting voltage pulse is transmitted to the capacitor 3d. As the magnet 1 rotates, these voltage pulses are input to the capacitors 3a, 3b, 3c, and 3d in order of the capacitor 3a, the capacitor 3c, the capacitor 3b, and the capacitor 3d.

The electric charges stored in the capacitors 3a, 3b, 3c, and 3d by the voltage pulses are each regulated into a DC current having a voltage equal to or less than a preset voltage by the constant voltage circuitry 4, and the DC current is used as the power source for the controller 5 and the storage 7. The pulse detector 6 detects the voltages output from the capacitors 3a, 3b, 3c, and 3d to thereby detect the positions of occurrence of the power generation pulses, that is, in which of the power generation devices 2a and 2b the pulse having either the forward direction voltage or the inverse direction voltage has generated.

When the pulse detector 6 detects a pulse, the controller 5 performs the counting operation. In the counting operation, the controller 5 reads out multi-rotation count data as of the previous pulse from the storage 7, and generates new multi-rotation count data on the basis of information about the pulse occurrence position obtained from the pulse detector 6. In addition, the controller 5 writes in the newly generated multi-rotation count data to the storage 7.

After performing the counting operation, the controller 5 performs the wait operation to wait for a preset time, and then operates the discharge circuitry 8 to discharge the capacitors 3a, 3b, 3c, and 3d.

Next, an operation in the powered state will be described. When electric power is supplied from outside the multi-rotation data counting circuitry 50, power from an amplifier, for example, is supplied to the constant voltage circuitry 4, and is used as the power source for the controller 5 and the storage 7. The controller 5 reads out multi-rotation count data as of the previous pulse from the storage 7.

In accordance with rotation of the magnet 1 attached to the rotating shaft 1a, a power generation pulse is generated in each of the power generation devices 2a and 2b due to large Barkhausen effect. Of the voltage pulses output by the power generation device 2a, the forward-direction voltage pulse is half-wave rectified by the half-wave rectification circuitry 23a, and the resulting voltage pulse is transmitted to the capacitor 3a. Of the voltage pulses output by the power generation device 2a, the inverse-direction voltage pulse is half-wave rectified by the half-wave rectification circuitry 23a, and the resulting voltage pulse is transmitted to the capacitor 3b. Of the voltage pulses output by the power generation device 2b, the forward-direction voltage pulse is half-wave rectified by the half-wave rectification circuitry 23b, and the resulting voltage pulse is transmitted to the capacitor 3c. Of the voltage pulses output by the power generation device 2b, the inverse-direction voltage pulse is half-wave rectified by the half-wave rectification circuitry 23b, and the resulting voltage pulse is transmitted to the capacitor 3d. As the magnet 1 rotates, these voltage pulses are input to the capacitors 3a, 3b, 3c, and 3d in order of the capacitor 3a, the capacitor 3c, the capacitor 3b, and the capacitor 3d.

When the electric charges of the power generation pulses are stored in the capacitors 3a, 3b, 3c, and 3d, the pulse detector 6 detects the position of occurrence of each of the power generation pulses, that is, in which of the power generation devices 2a and 2b the pulse having either the forward direction voltage or the inverse direction voltage has arisen.

The controller 5 creates new multi-rotation count data on the basis of information about the pulse occurrence position obtained from the pulse detector 6. After performing the counting operation, the controller 5 waits for a preset time, and then operates the discharge circuitry 8 to discharge the capacitors 3a, 3b, 3c, and 3d. When the power source is disconnected, the controller 5 writes in the multi-rotation count data to the storage 7.

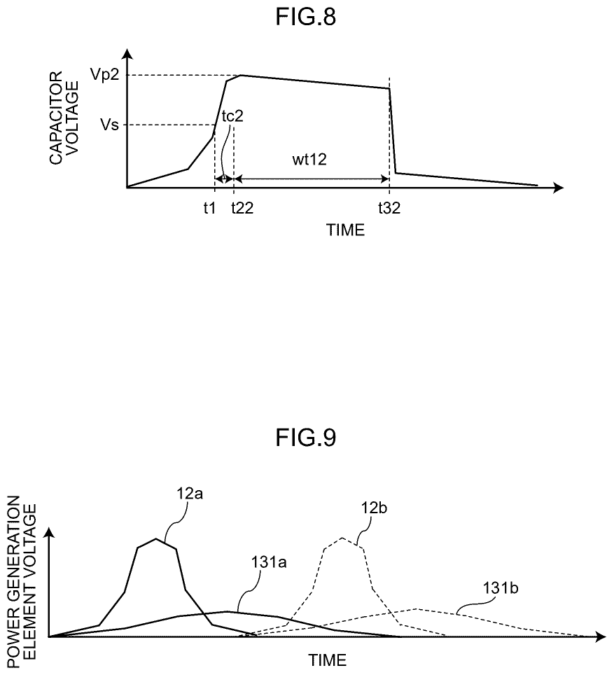

FIG. 7 is a diagram illustrating an example of power generation pulse waveform in the unpowered state, of the batteryless encoder according to the first embodiment. FIG. 8 is a diagram illustrating an example of power generation pulse waveform in the powered state, of the batteryless encoder according to the first embodiment. In the unpowered state, the controller 5 reads out the multi-rotation count data as of the previous pulse from the storage 7, creates new multi-rotation count data on the basis of information about the pulse occurrence position obtained from the pulse detector 6, and writes in the multi-rotation count data to the storage 7, during the counting operation. Meanwhile, in the powered state, the controller 5 performs only generation of the new multi-rotation count data on the basis of information about the pulse occurrence position obtained from the pulse detector 6 during the counting operation.

As described above, the electric charges stored in the capacitors 3a, 3b, 3c, and 3d are used as the power source for the controller 5 in the unpowered state. This causes a peak Vpl of the voltage of the capacitor during the counting operation in the unpowered state to be less than a peak Vp2 of the voltage of the capacitor during the counting operation in the powered state. On the other hand, the counting operation in the unpowered state includes more tasks than the counting operation in the powered state. This causes time tc1 required for completion of the counting operation in the unpowered state to be longer than time tc2 required for completion of the counting operation in the powered state. Accordingly, setting a same time to waiting time wt11 for use in the unpowered state and to waiting time wt12 for use in the powered state will cause time t31 for starting the discharging operation in the unpowered state to be later than time t32 for starting the discharging operation in the powered state. This hinders detection in a high-speed rotation.

The batteryless encoder 100 according to the first embodiment is capable of independently setting waiting time wt11 for use in the unpowered state and waiting time wt12 for use in the powered state. This enables the discharging operation to be started at a same timing in both the unpowered state and the powered state. Note that waiting time wt11 for use in the unpowered state and waiting time wt12 for use in the powered state can be set to a same time to start discharging at different timings.

As described above, in the batteryless encoder 100 according to the first embodiment, the controller 5 discharges the capacitor 3a after performing the counting operation of the first pulse 12a and at a time when electric charge supply from both of the first pulse 12a and the second pulse 13a has ended. This prevents a situation in which the amount of electric charge in one of the capacitors 3a, 3b, 3c, and 3d increases and the voltage of the capacitor increases again after performing the discharge operation. This can thus suppress counting a power generation pulse redundantly.

Note that the foregoing description has been described in terms of the batteryless encoder 100 configured to include the two power generation devices 2a and 2b as an example, but the number of the power generation devices may be one or three or more. Use of a higher number of power generation devices can provide higher resolution in detection of the rotation angle of the magnet 1.

The batteryless encoder 100 according to the first embodiment described above sets the waiting time to be waited in the wait operation of the controller 5 to a time that at least accumulating of the electric charges of the first pulses 12a and 12b and the second pulses 13a and 13b is completed, and there is no increase in the voltages of the capacitors 3a, 3b, 3c, and 3d. However, the waiting time to be waited in the wait operation of the controller 5 may be set to a time different from the time of the foregoing example. For example, the waiting time may be set to a time that at least accumulating of the electric charge of a first pulse is completed, and there is no increase in the voltages of the capacitors 3a, 3b, 3c, and 3d. In this respect, the batteryless encoder operates in such a manner that rotation of the rotating shaft causes a first pulse to be generated as the magnet rotates due to large Barkhausen effect of the Wiegand wire of each of the power generation devices, and causes a second pulse to be generated as the magnet 1 rotates due to induced electromotive force of the coil of each of the power generation devices, each as the power generation pulse.

FIG. 9 is a diagram illustrating an example of power generation pulse waveforms of the power generation devices of the batteryless encoder according to a variation of the first embodiment. The batteryless encoder 100 according to the variation of the first embodiment sets the waiting time to a time that at least accumulating of the electric charge of a first pulse is completed, and there is no increase in the voltages of the capacitors 3a, 3b, 3c, and 3d. As illustrated in FIG. 9, when the rotating shaft 1a rotates at a low rate of rotation or due to characteristics of the coils 22a and 22b, second pulses 131a and 131b may exhibit characteristics of low peaks of the second pulses 131a and 131b voltages, thereby resulting in a situation in which the voltages of the capacitors 3a, 3b, 3c, and 3d do not exceed a pulse detection threshold even when the electric charges of the second pulses 131a and 131b are accumulated in the capacitors 3a, 3b, 3c, and 3d. That is, the batteryless encoder according to the variation of the first embodiment performs the wait operation using a waiting time that has been preset to a time that at least accumulating of the electric charges of the first pulses 12a and 12b illustrated in FIG. 9 is completed, and there is no increase in the voltages of the capacitors 3a, 3b, 3c, and 3d, and then performs the discharging operation. Even in such case, the waiting time to be set can be a time, in regard to one of the capacitors 3a, 3b, 3c, and 3d, that accumulating of the electric charges of the first pulses 12a and 12b is completed, and there is no increase in the voltages of the capacitors 3a, 3b, 3c, and 3d. Specifically, the waiting time can be a time, in regard to the capacitor 3a, that accumulating of the electric charge of the first pulse 12a is completed, and there is no increase in the voltage of the capacitor 3a.

Note that the time that accumulating of the electric charges of the first pulses 12a and 12b is completed, and there is no increase in the voltages of the capacitors 3a, 3b, 3c, and 3d is the same for all the capacitors 3a, 3b, 3c, and 3d. The waiting time may therefore be set to a time, in regard to the capacitor 3b, that accumulating of the electric charge of the first pulse 12a is completed, and there is no increase in the voltage of the capacitor 3b; to a time, in regard to the capacitor 3c, that accumulating of the electric charge of the first pulse 12b, and there is no increase in the voltage of the capacitor 3c; and/or to a time, in regard to the capacitor 3d, that accumulating of the electric charge of the first pulse 12b is completed, and there is no increase in the voltage of the capacitor 3d.

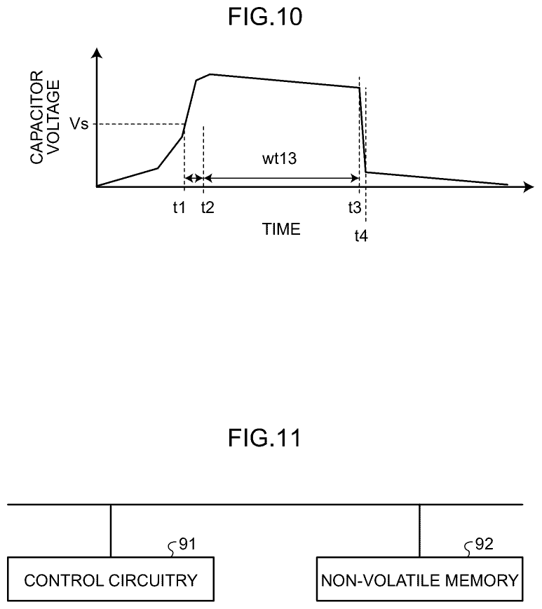

An operation of the batteryless encoder 100 will next be described for a case, as an example, where the counting operation is performed on the first pulse 12a in the context of the variation illustrated in FIG. 9. FIG. 10 is a diagram illustrating an example of power generation pulse waveform of a corresponding capacitor of the batteryless encoder according to the variation of the first embodiment. At time t1, the voltage of the capacitor 3a exceeds the pulse detection threshold Vs. This causes the controller 5 to start the counting operation. At time t2, when the counting operation finishes, the controller 5 performs the wait operation. After waiting for preset waiting time wt13, i.e., at time t3, the controller 5 performs the discharging operation to operate the discharge circuitry 8 to discharge the capacitor 3a. Waiting time wt13 is a time that at least accumulating of the electric charge of the first pulse 12a is completed, and there is no increase in the voltage of the capacitor 3a. As illustrated in FIG. 10, when the discharging operation finishes at time t4, the voltage of the capacitor of the capacitor 3a falls below the pulse detection threshold Vs, under which condition the first pulses 12a and 12b are detectable.

Even such variation can suppress redundant counting of the first pulses 12a and 12b that have already been counted, and can suppress counting, as different pulses, the first pulses 12a and 12b and the second pulses 131a and 131b. In addition, setting the waiting time to a time that accumulating of the electric charge of a power generation pulse is completed, and there is no increase in the voltages of the capacitors 3a, 3b, 3c, and 3d eliminates the need to wait for the time of self-discharge until the voltages of the capacitors 3a, 3b, 3c, and 3d decrease by self-discharge to a voltage less than or equal to the pulse detection threshold. This reduces the time required for the voltages of the capacitors 3a, 3b, 3c, and 3d to decrease to a detectable level of the first pulses 12a and 12b, thereby enabling a detection in a high-speed rotation to be provided more advantageously.

FIG. 11 is a diagram illustrating a hardware configuration of the controller and the storage of the batteryless encoder according to the first embodiment and the variation. The controller 5 is implemented in a control circuitry 91, which is designed to provide various operations.

The control circuitry 91 can be a large scale integration (LSI) designed to provide various operations by conduction of electricity, and may be an integrated circuit such as, for example, an application specific integrated circuit (ASIC). The control circuitry 91 integrally includes circuits for at least performing the counting operation, the wait operation, and the discharging operation. The storage 7 is implemented in a non-volatile memory 92, which retains information without supply of power. The non-volatile memory 92 can be a memory with low power consumption and high performance, and can be, for example, a ferroelectric random access memory (FeRAM) or the like.

In addition, the control circuitry 91 may be a semiconductor integrated circuit designed to include the constant voltage circuitry 4, the pulse detector 6, the discharge circuitry 8, the enable circuitry 9, the power source switching circuitry 10, and the external circuitry interface 11, in addition to the controller 5. For example, the control circuitry 91 may be configured as an ASIC or an LSI that integrally includes these circuits. Moreover, the control circuitry 91 may be a semiconductor integrated circuit designed to include the constant voltage circuitry 4, the controller 5, the pulse detector 6, the discharge circuitry 8, the enable circuitry 9, the power source switching circuitry 10, the external circuitry interface 11, the capacitors 3a, 3b, 3c, and 3d, the storage 7, and the half-wave rectification circuitries 23a and 23b.

The configurations described in the foregoing embodiment are merely examples of aspects. These configurations can be combined with another known technology, and can be partly omitted and/or modified without departing from the gist.

### REFERENCE SIGNS LIST

1 magnet; 1a rotating shaft; 2a, 2b power generation device; 3a, 3b, 3c, 3d capacitor; 4 constant voltage circuitry; 5 controller; 6 pulse detector; 7 storage; 8 discharge circuitry; 9 enable circuitry; 10 power source switching circuitry; 11 external circuitry interface; 12a, 12b first pulse; 13a, 13b, 131a, 131b second pulse; 21a, 21b wire; 22a, 22b coil; 23a, 23b half-wave rectification circuitry; 50 multi-rotation data counting circuitry; 70 electric motor drive; 91 control circuitry; 92 non-volatile memory; 100 batteryless encoder; 200 motor.

1. An encoder comprising:
a magnet attached to a rotating shaft;
a power generation device:
including a Wiegand wire and a coil wound around the Wiegand wire;
disposed to face the magnet;
generating a first pulse by the Wiegand wire due to large Barkhausen effect as the magnet rotates; and
generating a second pulse by the coil due to induced electromotive force as the magnet rotates a capacitor configured to accumulate electric charges of the first pulse and the second pulse;
a pulse detector configured to output a pulse detection signal when a voltage of the capacitor exceeds a pulse detection threshold; and
a controller that:
is operable by electric power supplied from the capacitor;
performs counting operation as an operation to count up multi-rotation data on a basis of the pulse detection signal, a wait operation to wait for a preset waiting time, and a discharging operation to discharge the capacitor after the wait operation, wherein
the waiting time is a time that at least accumulating of the electric charge of the first pulse is completed, and there is no increase in the voltage of the capacitor.

2. The encoder according to claim 1, wherein
the waiting time is a time that at least accumulating of the electric charges of the first pulse and the second pulse are completed, and there is no increase in the voltage of the capacitor.

3. The encoder according to claim 2, comprising
a plurality of the power generation devices.

4. The encoder according to claim 1, comprising:
a power source switching circuitry configured to switch between:
an operation of outputting electric power supplied from an outside to the controller and to a storage that stores the multi-rotation data; and
an operation of outputting the electric power supplied from the capacitor to the controller and to the storage, wherein
the waiting time is settable to different values for when the encoder is in a powered state and for when the encoder is in an unpowered state, the powered state being a state in which the electric power supplied from an outside is output to the controller, the unpowered state being a state in which the electric power supplied from the capacitor is output to the controller.

5. A motor comprising an electric motor drive including the rotating shaft and the encoder according to claim 1.
